(19) United States
(12) Patent Application Publication
(10) Pub. No.: US 2015/0192924 A1
(43) Pub. Date: Jul. 9, 2015

(54) METHOD OF MONITORING ENVIRONMENTAL VARIATIONS IN A SEMICONDUCTOR FABRICATION EQUIPMENT AND APPARATUS FOR PERFORMING THE SAME

(71) Applicant: Samsung Electronics Co., Ltd., Suwon-Si (KR)

(72) Inventor: Soon-Chul LEE, Suwon-si (KR)

(21) Appl. No.: 14/468,979

(22) Filed: Aug. 26, 2014

Related U.S. Application Data
(60) Provisional application No. 61/923,292, filed on Jan. 3, 2014.

(30) Foreign Application Priority Data
Mar. 4, 2014 (KR) 10-2014-0025401

(51) Int. Cl. G05B 19/418

(52) U.S. Cl. CPC G05B 19/41875; G05B 2219/2602

(57) ABSTRACT

A method of monitoring a semiconductor fabrication equipment—while tracking wafer information with respect to wafers that are processed in the semiconductor fabrication equipment. Real-time environmental information with respect to internal environmental variations of the semiconductor fabrication equipment may also be obtained. The real-time environmental information may be combined with the wafer information to obtain compiled real-time information for each of the wafers. A cause of a defect produced in a wafer may be accurately identified, and remedied, based on the compiled real-time information for each of the wafers.

### CROSS-REFERENCE TO RELATED APPLICATION

This application is a non-provisional application that claims priority to U.S. Provisional Application No. 61/923,292 filed on Jan. 3, 2014, and also claims priority under 35 U.S.C. §119 to Korean Patent Application No. 10-2014-0025401 filed on Mar. 4, 2014, the entire contents of each of which is incorporated by reference in its entirety.

### BACKGROUND

1. Field

Example embodiments relate to a method of monitoring a semiconductor fabrication equipment and an apparatus for performing the same. More particularly, example embodiments relate to a method of monitoring environmental conditions and environmental variations in a spinner, and an apparatus for performing the method.

2. Description of the Related Art

Generally, a spinner may coat a photoresist film on a semiconductor substrate. Defects such as particles may be generated on the photoresist film and the semiconductor substrate due to internal environmental disruptions within the spinner.

Conventionally, defects within the production of semiconductors may be identified. However, causes of the defects may not be accurately determined. Thus, the same defect or defects may be repeatedly generated.

### SUMMARY

Some example embodiments provide a method of monitoring a semiconductor fabrication equipment that may be capable of accurately identifying causes of semiconductor defects.

Some example embodiments also provide an apparatus for performing the above-mentioned method.

According to some example embodiments, a method of monitoring a semiconductor fabrication equipment is provided. In the method of monitoring the semiconductor fabrication equipment, wafer information with respect to wafers, which may be processed in the semiconductor fabrication equipment, may be obtained. Real-time information with respect to internal environmental variations of the semiconductor fabrication equipment may also be obtained. The real-time information of the semiconductor fabrication equipment may then be combined with the wafer information to obtain real-time information for each of the wafers.

In some example embodiments, the compiled real-time information may include a concentration of a reaction material, a number of particles, a pressure difference, a wind speed, a temperature, etc., within the semiconductor fabrication equipment.

In some example embodiments, the concentration of the reaction material may include a concentration of ammonia.

In some example embodiments, the method may further include selectively interlocking the semiconductor fabrication equipment based on the real-time information by each of the wafers.

In some example embodiments, the method may further include obtaining a cause of a wafer defect, which may be generated for the wafers, based on the compiled real-time information for each of the wafers.

In some example embodiments, the semiconductor fabrication equipment may include a spinner.

According to some example embodiments, there may be provided an apparatus for monitoring a semiconductor fabrication equipment. The apparatus may include a control server, a sensor unit and a combination server. The control server may store wafer information with respect to wafers processed in the semiconductor fabrication equipment. The sensor unit may obtain real-time environmental information with respect to internal environmental variations of the semiconductor fabrication equipment. The combination server may combine the real-time environmental information with the wafer information to obtain compiled real-time information for each of the wafers.

In some example embodiments, the sensor unit may include a concentration sensor configured to measure a concentration of a reaction material, a particle sensor configured to measure numbers of particles, a pressure sensor configured to measure a pressure difference, a speed sensor configured to measure a wind speed, a temperature sensor configured to measure a temperature, etc., within the semiconductor fabrication equipment.

In some example embodiments, the material sensor may include an ammonia sensor configured to measure a concentration of ammonia.

In some example embodiments, the apparatus may further include a monitoring server configured to display information based on the compiled real-time information for each of the wafers.

In some example embodiments, the monitoring server may selectively output an interlocking signal based on the compiled real-time information for each of the wafers.

In some example embodiments, the monitoring server may display a cause of a wafer defect, which may be generated for the wafers, based on the compiled real-time information for each of the wafers.

In some example embodiments, the apparatus may further include a relay server configured to transmit the wafer information and the compiled real-time information for each of the wafers between the control server and the combination server.

In some example embodiments, the semiconductor fabrication equipment may include a spinner.

According to some example embodiments, the compiled real-time information for each of the wafers may be obtained by combining the real-time environmental information with respect to the internal environmental variations with the wafer information. Thus, the cause of the defect generated in the wafer may be accurately identified based on the compiled real-time information for each of the wafers. Further, the semiconductor fabrication equipment may be selectively interlocked based on the compiled real-time information for each of the wafers so that the generation of the defect may be prevented.

### BRIEF DESCRIPTION OF THE DRAWINGS

Example embodiments will be more clearly understood from the following detailed description taken in conjunction with the accompanying drawings. FIGS. 1 to 4 represent non-limiting, example embodiments as described herein.

FIG. 1 is a block diagram illustrating an apparatus for monitoring a semiconductor fabrication equipment in accordance an example embodiment;

FIG. 2 is a flow chart illustrating a method of monitoring a semiconductor fabrication equipment using the apparatus of FIG. 1;

FIG. 3 is a block diagram illustrating an apparatus for monitoring a semiconductor fabrication equipment in accordance with an example embodiment; and

FIG. 4 is a flow chart illustrating a method of monitoring a semiconductor fabrication equipment using the apparatus of FIG. 3.

### DETAILED DESCRIPTION OF EXAMPLE EMBODIMENTS

Various example embodiments will be described more fully hereinafter with reference to the accompanying drawings, in which some example embodiments are shown. The example embodiments may, however, be embodied in many different forms and should not be construed as limited to the example embodiments set forth herein. Rather, these example embodiments are provided so that this disclosure will be thorough and complete, and will fully convey the scope of the example embodiments to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized example embodiments (and intermediate structures). As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, example embodiments will be explained in detail with reference to the accompanying drawings.

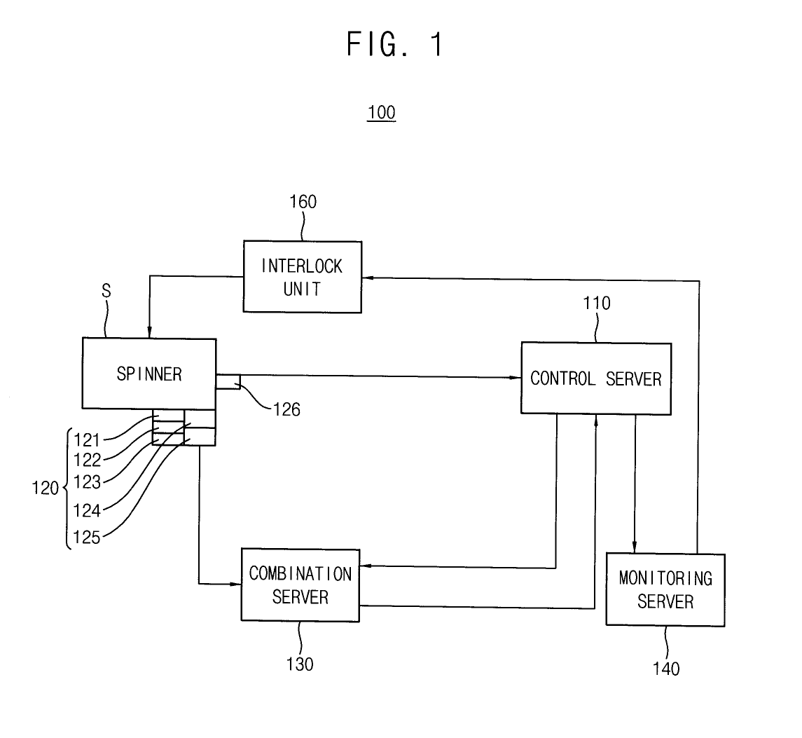

FIG. 1 is a block diagram illustrating an apparatus for monitoring a semiconductor fabrication equipment in accordance with an example embodiment.

Referring to FIG. 1, an apparatus 100 for monitoring a semiconductor fabrication equipment in accordance with an example embodiment may include a control server 110, a sensor unit 120, a combination server 130 and a monitoring server 140.

In an example embodiment, the semiconductor fabrication equipment may include a spinner S. The spinner S may coat a photoresist material on a wafer to form a photoresist film. The spinner S may include a spin chuck configured to rotate the wafer, a nozzle configured to inject a chemical material to the wafer, and a robot configured to transfer the wafer to the spin chuck. Alternatively, the semiconductor fabrication equipment may include a deposition apparatus, an exposure apparatus, or other similar apparatus for fabricating semiconductors.

The control server 110 may be connected to the spinner S through a network. The control server 110 may receive information on the wafers loaded into the spinner S through the network. When the wafers may be loaded into the spinner S, an identification unit 126 in the spinner S may identify the wafer via the use of wafer information. The identified wafer information may be transmitted to the control server 110 through the network. The wafer information may include an identification number for each of the wafers, as well as processes that are performed on the wafer, the number of times that the wafer went through a spin coating process, etc.

The sensor unit 120 may detect internal environmental conditions and internal environmental variations of the spinner S in real time to obtain real-time wafer information. The sensor unit 120 may include at least one sensor configured to measure the internal environment of the spinner S. In example embodiments, the sensor unit 120 may include a concentration sensor 121, a particle sensor 122, a pressure sensor 123, a speed sensor 124 and a temperature sensor 125.

The concentration sensor 121 may measure a concentration of a reaction material in the spinner S in real time. For example, the concentration sensor 121 may include an ammonia sensor configured to measure a concentration of ammonia introduced into the spinner S. The ammonia may be a principal factor for determining a critical dimension (CD) of a pattern on the wafer. Alternatively, the concentration sensor 121 may be changed in accordance with the type of semiconductor fabrication equipment.

The particle sensor 122 may measure numbers of particles generated in the spinner S in real time. The particles may be a principal factor for determining whether the pattern is abnormal. Thus, it may be required to strictly manage the allowable numbers of the particles.

The pressure sensor 123 may measure a pressure difference in the spinner S in real time. The pressure difference may correspond to a pressure difference between the spin chuck and the robot in the spinner S. When the pressure difference between the spin chuck and the robot may be beyond an allowable range, an air current in the spinner S may be changed. The changed air current may cause the particles to travel to the spin chuck.

The speed sensor 124 may measure a wind speed in the spinner S in real time. When the wind speed may be beyond an allowable range, an amount of the particles that travel to the spin chuck may be increased.

The temperature sensor 125 may measure a temperature in the spinner S in real time. The temperature sensor 125 may compare a measured temperature with an allowable temperature.

In an example embodiment, the sensor unit 120 may include at least one of the concentration sensor 121, the particle sensor 122, the pressure sensor 123, the speed sensor 124 and the temperature sensor 125. Additionally, the sensor unit 120 may further include other sensors configured to detect the internal environment of the spinner S. The additional sensors may include a humidity sensor configured to measure humidity in the spinner S. That is to say, the sensor unit 120 may include various sensors in accordance with the type of semiconductor fabrication equipment.

The combination server 130 may be connected to the sensor unit 120 through a network. The combination server 130 may receive the real-time environmental information measured by the sensor unit 120. For example, the concentration measured by the concentration sensor 121, the number of particles measured by the particle sensor 122, the pressure difference measured by the pressure sensor 123, the wind speed measured by the speed sensor 124, and the temperature measured by the temperature sensor 125, etc., may be transmitted to the combination server 130 through the network.

Further, the combination server 130 may be connected to the control server 110 through a network. Thus, the combination server 130 may receive the wafer information from the control server 110. The combination server 130 may combine the real-time environmental information with respect to the internal environment of the spinner S, which may be transmitted in real time from the sensor unit 120, for each of the wafers to obtain compiled real-time information for each of the wafers. The compiled real-time information for each of the wafers may include the concentration of the reaction material, the number of the particles, the pressure difference, the wind speed, the temperature, etc., in real time. The combination server 130 may divide and store the compiled real-time information for the wafers. The combination server 130 may transmit the compiled real-time information for each of the wafers to the control server 110.

The monitoring server 140 may receive the compiled real-time information for each of the wafers from the control server 110. The monitoring server 140 may display the compiled real-time information for each of the wafers on a monitor. Alternatively, the monitoring server 140 may directly receive the compiled real-time information for each of the wafers from the combination server 130.

In an example embodiment, the compiled real-time information for each of the wafers displayed on the monitor may include the identification numbers of the wafers, the concentration of the reaction material, the number of the particles, the pressure difference, the wind speed, the temperature, etc. Thus, the monitoring server 140 may individually display the concentration of the reaction material, the number of the particles, the pressure difference, the wind speed, the temperature, etc., for each of the wafers, as well as the number of times that the wafer has undergone a spin coating process. Therefore, a real-time variation transition of the internal environment of the spinner S may be accurately recognized based on the compiled real-time information for each of the wafers displayed on the monitoring server 140.

Further, when the internal environmental variation of the spinner S detected by the sensor unit 120 may be beyond an allowable range, the monitoring server 140 may output an interlock signal to an interlock unit 160. The interlock unit 160 may immediately stop the spinner S. Thus, because the spinner S may be immediately suspended when the internal environmental variation of the spinner S may be beyond the allowable range, an abnormal process may not be performed on the wafers. As a result, defects may not be caused in the wafers.

Although defects may be generated in the wafers, any one of the internal environmental conditions within the semiconductor fabrication equipment, which may cause the defect, may be recognized from the monitoring server 140 so that a repair may be taken as soon as possible to correct the internal environment of the semiconductor fabrication equipment. As a result, the defects caused by the corresponding internal environment may not be continuously generated in the wafers.

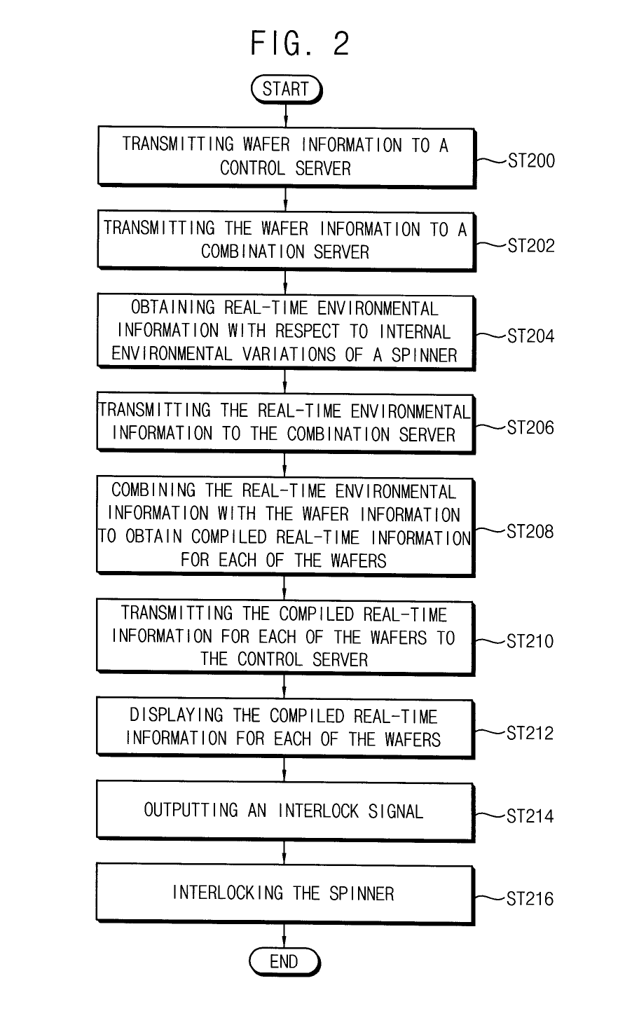

FIG. 2 is a flow chart illustrating a method of monitoring a semiconductor fabrication equipment using the apparatus in FIG. 1.

Referring to FIGS. 1 and 2, in step ST200, when the wafers may be loaded into the spinner S, the identification unit 126 of the spinner S may identify the wafer information of the wafers. The identified wafer information of the wafers may be transmitted to the control server 110.

In step ST202, the control server 110 may transmit the wafer information to the combination server 130. The combination server 130 may store the transmitted wafer information.

In step ST204, as a process may be performed on the wafers in the spinner S, the sensor unit 120 may detect the internal environmental variations of the spinner S in real time.

In an example embodiment, the concentration sensor 121 may measure a concentration of a reaction material in the spinner S in real time. The particle sensor 122 may measure a number of particles generated in the spinner S in real time. The pressure sensor 123 may measure a pressure difference in the spinner S in real time. The speed sensor 124 may measure a wind speed in the spinner S in real time. The temperature sensor 125 may measure a temperature in the spinner S in real time.

In step ST206, the sensor unit 120 may transmit the measured real-time environmental information to the combination server 130. Thus, the combination server 130 may receive the wafer information from the control server, and the real-time environmental information with respect to the internal environmental variations of the spinner S from the sensor unit 120.

In step ST208, the combination server 130 may combine the real-time environmental information with the wafer information to obtain the compiled real-time information for each of the wafers. Because the combination server 130 may recognize the identification number of the wafer to which the process may be currently performed based on the wafer information of the wafer transmitted from the control server 110, the combination server 130 may combine the real-time environmental information transmitted from the sensor unit 120 for the wafers in real time. Thus, the compiled real-time information for each of the wafers may include a first compiled real-time information with respect to a first wafer, a second compiled real-time information with respect to a second wafer, etc.

In step ST210, the combination server 130 may transmit the compiled real-time information for each of the wafers to the control server 110.

In step ST212, the control server 110 may transmit the compiled real-time information for each of the wafers to the monitoring server 140. The monitoring server 140 may display the compiled real-time information for each of the wafers on the monitor. The compiled real-time information for each of the wafers displayed on the monitor may include the identification numbers of the wafers, the concentration of the reaction material, the number of the particles, the pressure difference, the wind speed, the temperature, etc. Thus, the monitoring server 140 may individually display the concentration of the reaction material, the number of the particles, the pressure difference, the wind speed, the temperature, etc., for each of the wafers, and include information on the number of times that the wafer went through the spin coating process. Therefore, a real-time variation transition of the internal environment of the spinner S may be accurately recognized based on the compiled real-time information for each of the wafers displayed on the monitoring server 140.

In step ST214, when any one of the internal environmental variations of the spinner S detected by the sensor unit 120 may be beyond an allowable range, the monitoring server 140 may output an interlock signal to the interlock unit 160.

In an example embodiment, when the concentration of the reaction material in the spinner S measured by the concentration sensor 121 in real time may be beyond an allowable range, the monitoring server 140 may output an interlock signal to the interlock unit 160. For instance, when the number of the particles in the spinner S measured by the particle sensor 122 in real time may be beyond an allowable range, the monitoring server 140 may output the interlock signal to the interlock unit 160. When the pressure difference in the spinner S measured by the pressure sensor 123 in real time may be beyond an allowable range, the monitoring server 140 may output the interlock signal to the interlock unit 160.

When the wind speed in the spinner S measured by the speed sensor 124 in real time may be beyond an allowable range, the monitoring server 140 may output the interlock signal to the interlock unit 160. When the temperature in the spinner S measured by the temperature sensor 125 in real time may be beyond an allowable range, the monitoring server 140 may output the interlock signal to the interlock unit 160.

In step ST216, the interlock unit 160 may immediately stop the spinner S. Thus, an abnormal process may not be performed on the wafers. As a result, defects may be avoided in the wafers.

Although the defects may be generated in the wafers, any one of the internal environmental conditions, which may cause the defect, may be recognized from the monitoring server 140 so that a repair may be taken to correct the corresponding internal environmental condition. In an example embodiment, when the interlock signal may be caused by the real-time environmental information obtained from the concentration sensor 121, it can be acknowledged that the concentration of the reaction material in the spinner S may be beyond the allowable range. Thus, a supply amount of the reaction material may be controlled to prevent the defect from continuously being produced in the wafers. When the interlock signal may be caused by the real-time information obtained from the pressure sensor 123, it can be acknowledged that the pressure difference in the spinner S may be beyond the allowable range. Thus, the pressure difference may be controlled to prevent the defect from continuously being produced in the wafers. When the interlock signal may be caused by the real-time information obtained from the speed sensor 124, it can be acknowledged that the wind speed in the spinner S may be beyond the allowable range. Thus, the wind speed may be controlled to prevent the defect from continuously being produced in the wafers. When the interlock signal may be caused by the real-time information obtained from the temperature sensor 125, it can be acknowledged that the temperature in the spinner S may be beyond the allowable range. Thus, the temperature may be controlled to prevent the defect from continuously being produced in the wafers.

In an example embodiment, the defects may be caused by the environmental conditions that are identified in the real-time environmental information obtained from any one of the sensors 121-125. Alternatively, causes of the defects may be identified based on the real-time environmental information obtained from a plurality of the sensors 121-125.

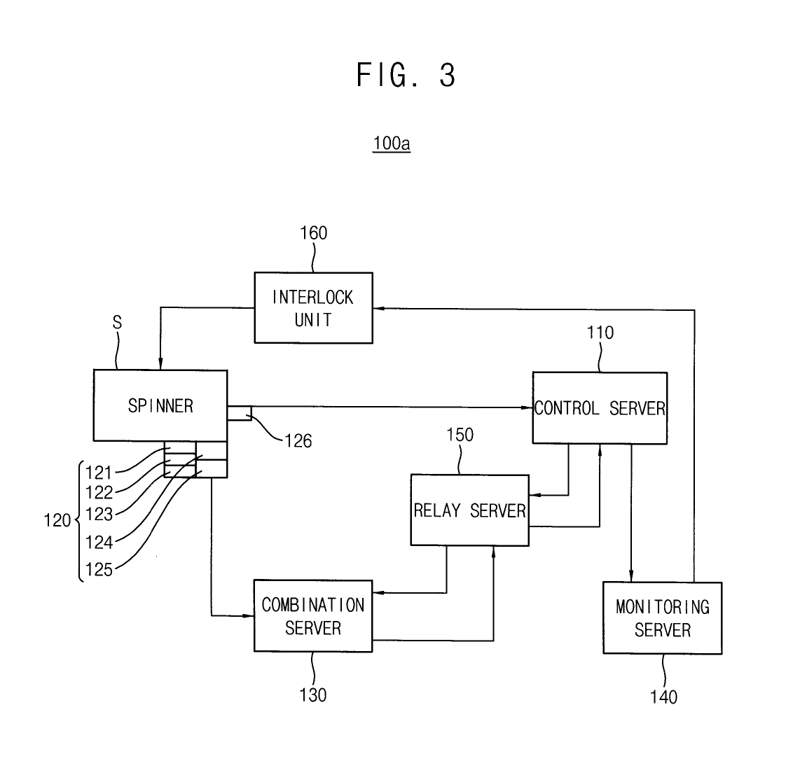

FIG. 3 is a block diagram illustrating an apparatus for monitoring a semiconductor fabrication equipment in accordance with an example embodiment.

An apparatus 100a for monitoring a semiconductor fabrication equipment in accordance with an example embodiment may include elements substantially the same as those of the apparatus 100 of FIG. 1 except for further including a relay server 150. Thus, the same reference numerals may refer to the same elements and any further illustrations with respect to the same elements may be omitted herein for brevity.

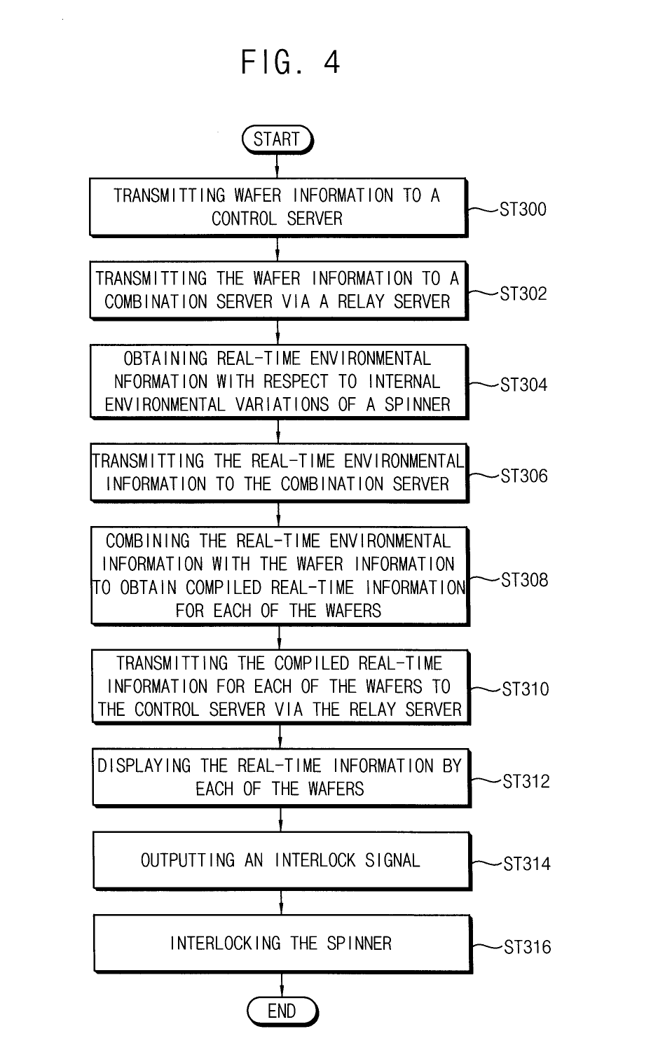

Referring to FIG. 4, relay server 150 may be arranged between the control server 110 and the combination server 130. The relay server 150 may receive the wafer information from the control server 110. The relay server 150 may transmit the wafer information to the combination server 130. Further, the relay server 150 may receive the compiled real-time information for each of the wafers from the combination server 130. The relay server 150 may transmit the compiled real-time information for each of the wafers to the control server 110.

In an example embodiment, the relay server 150 may be used when an information-processing type of the control server 110 may be different from an information-processing type of the combination server 130. That is, when the control server 110 and the combination server 130 may utilize different data-processing protocols, the relay server 150 may be used. Thus, when the control server 110 and the combination server 130 may have substantially the same data-processing protocols, the relay server 150 may not need to be used in the apparatus 100a.

FIG. 4 is a flow chart illustrating a method of monitoring a semiconductor fabrication equipment using the apparatus in FIG. 3.

Referring to FIGS. 3 and 4, in step ST300, when the wafers may be loaded into the spinner S, the identification unit 126 of the spinner S may identify the wafer information of the wafers. The identified wafer information of the wafers may be transmitted to the control server 110.

In step ST302, the control server 110 may transmit the wafer information to the combination server 130 via the relay server 150. The combination server 130 may store the transmitted wafer information.

In step ST304, while a process may be performed on the wafers in the spinner S, the sensor unit 120 may detect the internal environmental variations of the spinner S in real time.

In step ST306, the sensor unit 120 may transmit the measured real-time environmental information to the combination server 130. Thus, the combination server 130 may receive the wafer information from the control server, and the real-time environmental information with respect to the inner environment variations of the spinner S from the sensor unit 120.

In step ST308, the combination server 130 may combine the real-time environmental information with the wafer information to obtain the compiled real-time information for each of the wafers.

In step ST310, the combination server 130 may transmit the compiled real-time information for each of the wafers to the control server 110 via the relay server 150.

In step ST312, the control server 110 may transmit the compiled real-time information for each of the wafers to the monitoring server 140. The monitoring server 140 may display the compiled real-time information for each of the wafers on the monitor.

In step ST314, when any one of the internal environmental variations of the spinner S detected by the sensor unit 120 may be beyond an allowable range, the monitoring server 140 may output an interlock signal to the interlock unit 160.

In step ST316, the interlock unit 160 may immediately stop the spinner S. Thus, an abnormal process may not be performed on the wafers. As a result, defects may be avoided in the wafers.

Although the defects may be generated in the wafers, any one of the internal environmental conditions of the semiconductor fabrication equipment, which may cause the defect, may be recognized from the monitoring server 140 so that a repair may be performed on the semiconductor fabrication equipment.

According to an example embodiment, the compiled real-time information for each of the wafers may be obtained by combining the real-time environmental information with respect to the inner environment variations with the wafer information. Thus, the cause of the defect produced in the wafer may be accurately identified based on the compiled real-time information for each of the wafers. Further, the semiconductor fabrication equipment may be selectively interlocked based on the compiled real-time information for each of the wafers so that the generation of the defect may be prevented.

The foregoing is illustrative of example embodiments and are not to be construed as limiting thereof. Although a few example embodiments have been described, those skilled in the art will readily appreciate that many modifications are possible in the example embodiments without materially departing from the novel teachings and advantages of the present invention. Accordingly, all such modifications are intended to be included within the scope of the example embodiments as defined in the claims. In the claims, means-plus-function clauses are intended to cover the structures described herein as performing the recited function and not only structural equivalents but also equivalent structures. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A method of monitoring a semiconductor fabrication equipment, the method comprising:
obtaining wafer information on wafers processed in the semiconductor fabrication equipment;
obtaining real-time environmental information with respect to internal environmental variations of the semiconductor fabrication equipment while the wafers are processed in the semiconductor fabrication equipment; and
combining the real-time environmental information with the wafer information to obtain compiled real-time information for each of the wafers.

2. The method of claim 1, wherein the real-time environmental information with respect to the internal environmental variations includes information on one or more of a concentration of a reaction material, a number of particles, a pressure difference, a wind speed and a temperature in the semiconductor fabrication equipment.

3. The method of claim 2, wherein the concentration of the reaction material includes a concentration of ammonia.

4. The method of claim 1, further comprising:
selectively interlocking the semiconductor fabrication equipment based on the compiled real-time information for each of the wafers.

5. The method of claim 1, further comprising:
obtaining a cause of a wafer defect, which is identified in the wafers processed in the semiconductor fabrication equipment, based on the compiled real-time information for each of the wafers.

6. The method of claim 1, wherein the semiconductor fabrication equipment includes a spinner.

7. An apparatus for monitoring a semiconductor fabrication equipment, the apparatus comprising:
a control server configured to store wafer information for wafers processed in the semiconductor fabrication equipment;
a sensor unit configured to obtain real-time environmental information with respect to internal environmental variations of the semiconductor fabrication equipment while the wafers are processed in the semiconductor fabrication equipment; and
a combination server configured to combine the real-time environmental information with the wafer information to obtain compiled real-time information for each of the wafers.

8. The apparatus of claim 7, wherein the sensor unit includes one or more of a concentration sensor configured to measure a concentration of a reaction material, a particle sensor configured to measure a number of particles, a pressure sensor configured to measure a pressure difference, a speed sensor configured to measure a wind speed and a temperature sensor configured to measure a temperature in the semiconductor fabrication equipment.

9. The apparatus of claim 8, wherein the concentration sensor is configured to measure a concentration of ammonia.

10. The apparatus of claim 7, further comprising:
a monitoring server configured to display the compiled real-time information for each of the wafers.

11. The apparatus of claim 10, wherein the monitoring server selectively outputs an interlock signal for interlocking the semiconductor fabrication equipment based on the compiled real-time information for each of the wafers.

12. The apparatus of claim 10, wherein the monitoring server displays a cause of a defect, which is identified in the wafers produced by the semiconductor fabrication equipment, based on the compiled real-time information for each of the wafers.

13. The apparatus of claim 7, further comprising:
a relay server configured to transmit the wafer information and the compiled real-time information for each of the wafers between the control server and the combination server.

14. The apparatus of claim 7, wherein the semiconductor fabrication equipment includes a spinner.

15. A method of monitoring the performance of a semiconductor fabrication equipment, comprising:
processing a wafer in the semiconductor fabrication equipment;
obtaining compiled real-time environmental information on internal environmental conditions of the semiconductor fabrication equipment during the processing of the wafer; and
adjusting the internal environmental conditions of the semiconductor fabrication equipment based on the compiled real-time environmental information.

16. The method of claim 15, wherein the obtaining of the compiled real-time environmental information includes,
tracking wafer information on the wafer being processed in the semiconductor fabrication equipment,
monitoring the internal environmental conditions of the semiconductor fabrication equipment as the wafer is being processed,
generating real-time environmental information based on the monitored internal environmental conditions, and
combining the real-time environmental information with the wafer information to produce the compiled real-time information for the wafer.

17. The method of claim 16, wherein the monitoring of the internal environmental conditions includes monitoring one or more of a concentration of a reaction material, a number of particles, a pressure difference, a wind speed and a temperature in the semiconductor fabrication equipment.

18. The method of claim 15, wherein the adjusting of the internal environmental conditions includes selectively interlocking the semiconductor fabrication equipment based on the compiled real-time information.

19. The method of claim 15, further comprising:
identifying a cause of a wafer defect for the wafer that is processed in the semiconductor fabrication equipment, based on the compiled real-time information for the wafer,
wherein the adjusting of the internal conditions of the semiconductor fabrication equipment is also based on the identified cause of the wafer defect.

20. The method of claim 16, wherein the tracking of the wafer information includes tracking at least one of an identification number of the wafer, a process performed on the wafer, and a number of times that the wafer went through a spin coating process in the semiconductor fabrication equipment.
